(19) United States
(12) Patent Application Publication
(10) Pub. No.: US 2025/0170609 A1
(43) Pub. Date: May 29, 2025

(54) METHOD AND APPARATUS FOR COATING A SUBSTRATE

(71) Applicant: Ford Global Technologies, LLC, Dearborn, MI (US)

(72) Inventors: Christopher Michael Seubert, New Hudson, MI (US); Janice Lisa Tardiff, Plymouth, MI (US); Mark Edward Nichols, Saline, MI (US); Bita Ghaffari, Ann Arbor, MI (US)

(73) Assignee: Ford Global Technologies, LLC, Dearborn, MI (US)

(21) Appl. No.: 18/523,369

(22) Filed: Nov. 29, 2023

(51) Int. Cl. B05D 3/02; B05C 11/10; B05D 7/00

(52) U.S. Cl. CPC B05D 3/0227; B05C 11/1015; B05D 7/544

(57) ABSTRACT

An apparatus and method for coating a substrate includes preheating a first portion of the substrate to a first temperature. The method includes ejecting a first material from a material applicator so that the first material is applied to the preheated first portion of the substrate. The first material includes a first solvent component and a first coating component. The first temperature is greater than an ambient temperature and less than a boiling point of the first coating component.

### FIELD

The present disclosure relates to a method and apparatus for coating a substrate.

### BACKGROUND

The statements in this section merely provide background information related to the present disclosure and may not constitute prior art.

Typical coating applicators and methods can result in dripping or running of the coating which can result in less desirable aesthetic appearance or function of the coating. This can be particularly the case when some regions of a substrate to be coated are oriented differently than other regions relative to gravity.

Additionally, some coating applicators only work with relatively low viscosity materials which may have a higher tendency to run or drip.

The teachings of the present disclosure address these and other issues of typical coating applicators and methods.

### SUMMARY

This section provides a general summary of the disclosure and is not a comprehensive disclosure of its full scope or all of its features.

According to one form, the present disclosure provides for a method of coating a substrate includes preheating a first portion of the substrate to a first temperature, and ejecting a first material from a material applicator so that the first material is applied to the preheated first portion of the substrate. The first material includes a first solvent component and a first coating component. The first temperature is greater than an ambient temperature and less than a boiling point of the first coating component.

In variations of the method of the above paragraph, which can be implemented individually or in any combination: the preheating is performed by a heater located on a robotic tool, wherein the material applicator is located on the robotic tool; the preheating is performed by an infrared heater; the preheating of the first portion of the substrate is performed by a heater that directs heat in a targeted manner to the first portion of the substrate, the first portion being less than an entirety of the substrate; the preheating of the first portion of the substrate is performed by a heater that directs heat to an entirety of the substrate; the method further includes preheating a second portion of the substrate to a second temperature, the second temperature being greater than the first temperature and less than the boiling point of the first coating component, the second portion of the substrate being closer to a vertical orientation than the first portion of the substrate, and ejecting the first material from the material applicator so that the first material is applied to the preheated second portion of the substrate; the method further includes adjusting the first temperature based on an orientation, with respect to gravity, of the first portion of the substrate; the method further includes preheating a second portion of the substrate to a second temperature, the second temperature being different than the first temperature, and ejecting a second material from the material applicator so that the second material is applied to the preheated second portion of the substrate, the second material including a second solvent component and a second coating component that is different than the first coating component, wherein the second temperature is greater than the ambient temperature and less than a boiling point of the second coating component; the method further includes adjusting the first temperature based on a characteristic of the first coating component, wherein the characteristic includes at least one of an absorptivity, a heat absorption coefficient, and a heat transfer coefficient; the preheating of the first portion of the substrate is performed by a heater, wherein the heater is operated at the same time as the material applicator ejects the first material and the method further includes moving the heater and the material applicator, relative to the substrate, along a path such that the first portion is heated by the heater before the ejected first material is applied to the first portion; the preheating of the first portion of the substrate is performed by a heater, wherein the heater is operated at the same time as the material applicator ejects the first material and the method further includes moving the substrate, relative to the material applicator and the heater, along a path such that the first portion is heated by the heater before the ejected first material is applied to the first portion; the first temperature is within the range of 45° C. to 105° C., inclusive; the first temperature is sufficient to evaporate one or more solvents of the first solvent component to increase a viscosity of the first material to above 0.1 newton-second per square meter within 60 seconds of the first material contacting the substrate; the first temperature is sufficient to evaporate one or more solvents of the first solvent component to increase a viscosity of the first material by predetermined percentage 60 seconds of the first material contacting the substrate.

In another form, the present disclosure provides for a method of coating a substrate including: preheating a first portion of the substrate to a first temperature; ejecting a first material from a material applicator so that the first material is applied to the preheated first portion of the substrate, the first material including a first solvent component and a first coating component, wherein the first temperature is greater than an ambient temperature and less than a boiling point of the first coating component; preheating a second portion of the substrate to a second temperature, the second temperature being greater than the first temperature and less than the boiling point of the first coating component, the second portion of the substrate being closer to a vertical orientation than the first portion of the substrate; and ejecting the first material from the material applicator so that the first material is applied to the preheated second portion of the substrate.

In a variation of the method of the above paragraph, the preheating of the first portion of the substrate and the preheating of the second portion of the substrate are performed by a heater that directs heat in a targeted manner to the first portion of the substrate and in a targeted manner to the second portion of the substrate, the first portion being less than an entirety of the substrate and the second portion of the substrate being less than the entirety of the substrate.

In another form, the present disclosure provides for an apparatus for coating a substrate with at least one material. The apparatus includes a material applicator, a heater, at least one device configured to provide relative movement between the substrate and the material applicator and between the substrate and the heater, and a controller. The material applicator is configured to eject the at least one material. The controller is in communication with the at least one device, the material applicator, and the heater. The controller is configured to control operation of the at least one device, the material applicator, and the heater such that the heater directs heat toward a first portion of the substrate and the material applicator subsequently applies the at least one material to the heated first portion.

In variations of the apparatus of the above paragraph, which can be implemented individually or in any combination: the at least one material includes a solvent component and a coating component, wherein the controller is configured to operate the heater to heat the first portion to a first temperature that is greater than an ambient temperature and less than a boiling point of the coating component; the controller is configured to adjust operation of the heater to heat the first portion to a temperature that is based on an orientation of the first portion of the substrate relative to gravity; the controller is configured to adjust operation of the heater to heat the first portion to a temperature based on a characteristic of the at least one material, wherein the characteristic includes at least one of an absorptivity, a heat absorption coefficient, and a heat transfer coefficient.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic side view of a spray system for coating a substrate in accordance with the teachings of the present disclosure;

FIG. 2 is a schematic front view of a material applicator of the spray system of FIG. 1;

FIG. 3 is a schematic front view of an array body of the material applicator of FIG. 2;

FIG. 4 is a schematic cross-sectional view of the array body of FIG. 3;

FIG. 5 is a schematic side view of a portion of the spray system of FIG. 1, illustrating movement of the material applicator and a heater relative to the substrate in a plurality of orientations relative to gravity according to the teachings of the present disclosure;

FIG. 6 is a schematic side view of a portion of the spray system of FIG. 1, illustrating movement of the material applicator and the heater relative to the substrate in a plurality of orientations relative to gravity according to the teachings of the present disclosure;

FIG. 7 is a schematic side view of a portion of a spray system of a second configuration according to the teachings of the present disclosure;

FIG. 8 is a schematic side view of a portion of a spray system of a third configuration according to the teachings of the present disclosure; and

FIG. 9 is a schematic side view of a portion of a spray system of a fourth configuration according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. Examples are provided to fully convey the scope of the disclosure to those who are skilled in the art. Numerous specific details are set forth such as types of specific components, devices, and methods, to provide a thorough understanding of variations of the present disclosure. It will be apparent to those skilled in the art that specific details need not be employed and that the examples provided herein, may include alternative embodiments and are not intended to limit the scope of the disclosure. In some examples, well-known processes, well-known device structures, and well-known technologies are not described in detail.

The present disclosure provides a variety of devices, methods, and systems for controlling the application of paint to automotive vehicles in a high production environment, which reduce overspray and increase transfer efficiency of the paint. It should be understood that the reference to automotive vehicles is merely exemplary and that other objects that are painted, such as industrial equipment and appliances, among others, may also be painted in accordance with the teachings of the present disclosure. Further, the use of “paint” or “painting” should not be construed as limiting the present disclosure, and thus other materials such as coatings, primers, sealants, cleaning solvents, among others, are to be understood as falling within the scope of the present disclosure.

Generally, the teachings of the present disclosure are based on a droplet spray generation device in which a perforate membrane is driven by a piezoelectric transducer. This device and variations thereof are described in U.S. Pat. Nos. 6,394,363, 7,550,897, 7,977,849, 8,317,299, 8,191,982, 9,156,049, 7,976,135, 9,452,442, and U.S. Published Application Nos. 2014/0110500, 2016/0228902, and 2016/0158789, which are incorporated herein by reference in their entirety.

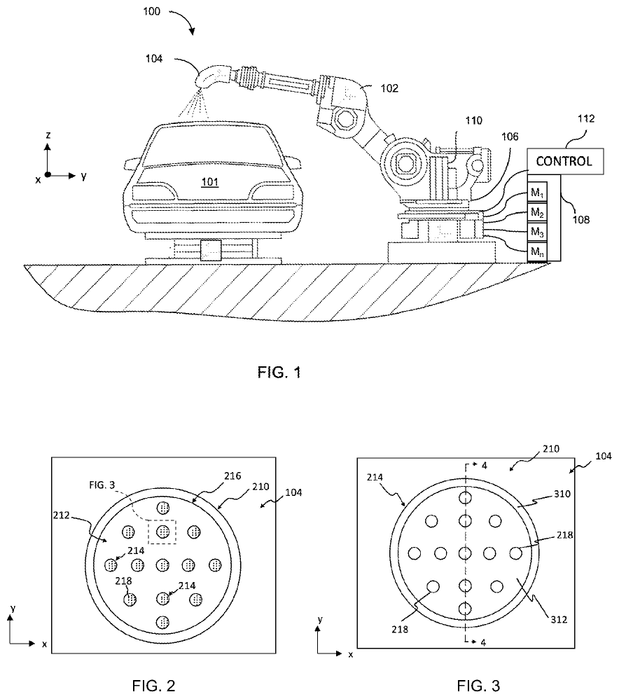

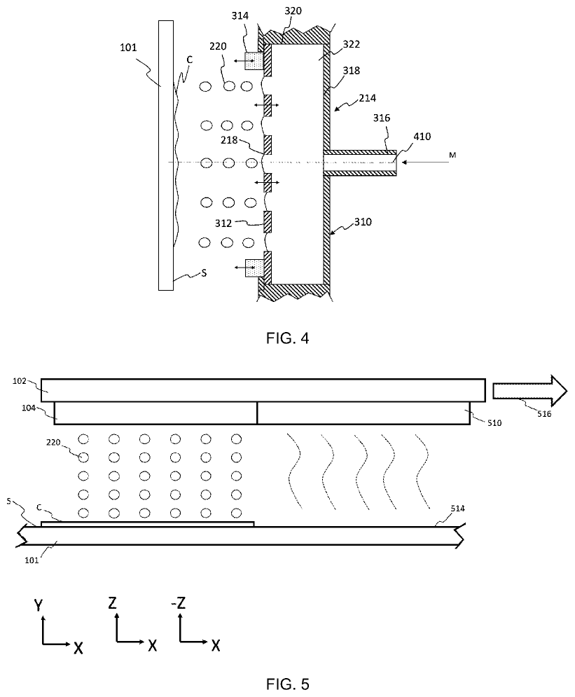

Referring now to FIG. 1, a side view of a spray system 100 for painting or coating a part or substrate 101 using a robotic tool (e.g., a robotic arm 102) is schematically depicted. While a robotic arm 102 is illustrated, other robotic tools can be used, as described below. The robotic arm 102 is coupled to at least one material applicator 104 and a rack 106. A material source 108 (e.g., a paint source) is included and includes at least one material M (materials M₁, M₂, M₃, . . . Mₙ shown in FIG. 1; also referred to herein simply as “material M”). In some aspects of the present disclosure the at least one material M includes different paint materials, different adhesive materials, different sealant materials, and the like. The robotic arm 102 moves according to XYZ coordinates with respect to rack 106 such that the material applicator 104 moves across a surface S (labeled in FIG. 4) of the substrate 101. Also, a power source 110 is configured to supply power to the robotic arm 102 and the rack 106. The robotic arm 102 and the rack 106 are configured to supply material M from the material source 108 to the material applicator 104 such that a coating is applied to the surface of the substrate 101.

Earth's gravity (i.e., gravity) acts in the negative Z direction of the coordinate systems used herein.

Referring to FIG. 2 front view of a material applicator 104 or atomizer according to the teachings of the present disclosure is schematically shown. The material applicator 104 can also be referred to as a print head. In one form of the present disclosure, the material applicator 104 includes an array body 210 or nozzle with an applicator array 212 including a plurality of micro-applicators 214 or sub-nozzles. In some aspects of the present disclosure, the array body 210 with the applicator array 212 is positioned on a base 216. In one configuration, the base 216 is supported at the end of the articulating robotic arm 102 (FIG. 1). In another configuration, the base 216 is supported by a gantry (not shown) or spray bar (not shown) which can be stationary (while the substrate 101 moves) or robotic to move in one, two, or three dimensions relative to a substrate 101 (shown in FIG. 4). Each of the micro-applicators 214 includes a plurality of apertures 218 through which a material M (FIG. 4) is ejected such that atomized droplets 220 (FIG. 4) of the material is provided.

As described above, the material M (FIG. 4) is generally a liquid material (e.g., primer, basecoat, clearcoat, etc.) but may optionally include interspersed solids, such as metallic flecks or other particles to provide a particular aesthetic look. The material M includes a coating component and a solvent component. The coating component is configured to remain on the substrate 101 after drying or curing to form the finished coating. The coating component may include one or more coating materials. It should be understood that the substrate 101 before the coating discussed herein is applied, may have a raw surface to which the coating is applied or may already have one or more other coatings (e.g., primer) thereon. The solvent component is a solvent or a blend of solvents that is configured to reduce the viscosity of the material below that of the coating component. The solvent component is configured so that the viscosity of the material M is such that the material M can be ejected from the small apertures 218 under actuation of the micro-applicator plate 312 by the actuator 314 but sufficient to inhibit the material M from flowing from the plurality of apertures 218 when the actuator 314 is off. The solvent component is configured to evaporate quicker than the coating component at temperatures below the boiling point of the coating component.

The micro-applicators 214 can be arranged in any arrangement, such as a regular or an irregular pattern across the array body 210. While illustrated as a circular shape, the array body 210 can be any shape. For example, in one form, the array body 210 can be a linear or rectangular shape and the micro-applicators 214 can be arranged in a linear or rectangular pattern.

Referring to FIGS. 3 and 4, each of the micro-applicators 214 includes a nozzle body 310, a micro-applicator plate 312, and an actuator 314. Each micro-applicator plate 312 defines a plurality of the apertures 218 extending through the micro-applicator plate 312. The actuator 314 can be a transducer such as a piezoelectric material. The micro-applicator plate 312 is in mechanical communication with the actuator 314 such that activation of the actuator 314 (e.g., the control module 112 providing electrical power to the actuator 314) vibrates or oscillates the micro-applicator plate 312 as schematically depicted by the horizontal (z-direction) double-headed arrows in FIG. 4.

In the example provided, the array body 210 includes a material inlet 316 corresponding to each micro-applicator 214. The array body 210 includes a back wall 318 and at least one sidewall 320 such that a reservoir 322 for containing the material M is provided between the back wall 318 and the micro-applicator plate 312. In the example provided, the at least one sidewall 320 is a single, cylindrically shaped sidewall. In another form, the at least one sidewall 320 includes a plurality of sidewalls or surfaces that define a perimeter of the reservoir 322. In the example provided, the back wall 318, the sidewall 320, and the side of the micro-applicator plate 312 that faces the back wall 318 cooperate to define the reservoir 322. The inlet 316 is in fluid communication with the reservoir 322 such that the material M flows through the inlet 316 and into the reservoir 322. In the example provided, the actuator 314 is positioned in contact with the micro-applicator plate 312 proximate an outer perimeter of the micro-applicator plate 312. In another form, not specifically shown, the actuator 314 is positioned between the micro-applicator plate 312 and the nozzle body 310 so that the nozzle body 310 supports the actuator 314 and the actuator 314 supports the micro-applicator plate 312. In one configuration, the actuator 314 is an annular shape disposed about an axis 410 of the micro-applicator 214. In another configuration, not specifically shown, the actuator 314 can be integrally formed with the micro-applicator plate 312 such that supplying power to the micro-applicator plate 312 oscillates the micro-applicator plate 312. In the example provided, a control module 112 (FIG. 1) is in electric communication with the actuator 314 to provide power to and control operation of the actuator 314.

Still referring to FIG. 4, the material M is supplied to the reservoir 322 at a very low pressure or no pressure, such that surface tension of the material M resists the material M from flowing through the apertures 218 of the micro-applicator plate 312 unless the actuator 314 is activated and oscillates. That is, when the actuator 314 is activated and vibrates, the material M is ejected through and/or from the plurality of apertures 218 to provide a stream of atomized droplets 220. The stream of atomized droplets 220 propagates generally parallel to the micro-applicator axis 410 and forms a coating layer C on a surface S of the substrate 101. The substrate 101 can be any suitable workpiece such as a vehicle part, frame, or body for example. As schematically depicted in FIG. 4, the atomized droplets 220 have a narrow droplet size distribution (e.g., average droplet diameter).

Referring to FIG. 5, a heater 510 can be positioned to preheat the substrate 101 before the material applicator 104 deposits the material M on the substrate 101. The heater 510 can be any suitable type of heater. In one form, the heater 510 is an infra-red radiation (IR) heater. In another form, the heater 510 is a convection heater.

In the example provided, the heater 510 is positioned, with regard to movement of the material applicator 104 relative to the substrate 101, in front of the material applicator 104. In the example provided, the heater 510 is mounted adjacent to the material applicator 104 on the robotic arm 102 for movement therewith. The control module 112 is configured to control the end of the robotic arm 102 to move along a predetermined path so that the material applicator 104 and heater 510 are spaced apart from the substrate 101 and so that the heater 510 heats a portion 514 of the substrate 101 in a targeted manner immediately before the material applicator 104 applies the material M to the portion 514. In other words, the heater can be configured to heat less than an entirety of the substrate.

In another form, not specifically shown, the heater 510 can be mounted to a separate robotic arm that is controlled by the control module 112 to follow the predetermined path at the same time as, but immediately preceding, the robotic arm 102 that has the material applicator 104 follows that predetermined path to apply the material M to the portion 514 after the portion 514 is heated in a targeted manner. In other words, the heater can be configured to heat less than an entirety of the substrate.

In another form, not specifically shown, a heater can heat the entire substrate immediately before the material applicator 104 deposits the material M. For example, the substrate 101 may be placed inside of a heating chamber (not shown), then the material applicator 104 can apply the material M within the chamber or immediately after removing the heated substrate 101 from the chamber.

Returning to the example provided, the path that the heater 510 and material applicator 104 follow is a path relative to the substrate 101. In other words, a robotic tool (e.g., robotic arm 102) can move the heater 510 and material applicator 104 while the substrate 101 remains stationary, or the heater 510 and material applicator 104 may remain stationary while a robotic tool (e.g., robotic arm 102 or conveyor system) moves the substrate 101, or one or more robotic tools can move the substrate 101, the heater 510 and the material applicator 104. In other words, as used herein, statements such as the heater 510 and material applicator 104 move relative to the substrate 101 encompass all of these configurations and are not referring to only the heater 510 and the material applicator 104 moving relative to the ground, unless specifically described as such.

The heater 510 and material applicator 104 can follow any path relative to the substrate 101. While the portion of the substrate 101 that is illustrated in FIGS. 5-9 is shown as flat for simplicity of explanation, the substrate 101 can have any shape and may include bends and/or curves. The path of the heater 510 and material applicator 104 relative to the substrate 101 can follow the bends and curves of the substrate 101.

FIG. 5 is shown with several alternative sets of coordinates to illustrate variations of a portion of a path that may be taken by the heater 510 and material applicator 104 relative to the substrate 101. While relative motion in the X direction is shown by arrow 516, it should be understood that the path may optionally be a two- or three-dimensional path that can include relative movement in other directions. In one form, a portion of the path can be such that gravity acts on the atomized droplets 220 transverse to the path and substantially parallel to the surface of the substrate 101 (e.g., into or out of the page as shown in FIG. 5). In another form, a portion of the path can be such that gravity acts on the atomized droplets 220 transverse to the path and toward the surface of the substrate 101 (e.g., down as shown in FIG. 5). In another form, a portion of the path can be such that gravity acts on the atomized droplets 220 transverse to the path and away from the surface of the substrate 101 (e.g., up as shown in FIG. 5).

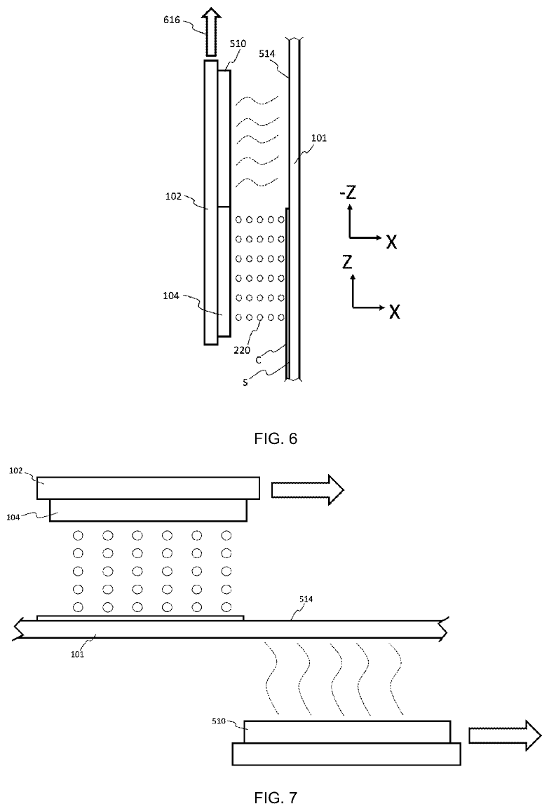

FIG. 6 is shown with several alternative sets of coordinates to illustrate variations of a portion of a path that may be taken by the heater 510 and material applicator 104 relative to the substrate 101. While relative motion in the Z direction is shown by arrow 616, it should be understood that the path may optionally be a two- or three-dimensional path that can include relative movement in other directions. In one form, a portion of the path can be such that gravity acts on the atomized droplets 220 substantially parallel to the path and substantially parallel to the surface of the substrate 101 (e.g., up or down as shown in FIG. 5).

While FIGS. 5 and 6 are shown with the path being along the X or Z axes for ease of illustration, it should be understood that the path and orientation of the substrate 101 can be not directly along any one axis such that gravity may act at an angle relative to the substrate 101 such that gravity acts in a direction that is not perpendicular or parallel to the substrate 101.

The path may be such that it traverses more than one portion of the substrate, with different portions being at different orientations relative to gravity. In other words, some portions of the substrate 101 may be more vertical (i.e., less horizontal) than other portions. For example, the path may be such that the heater 510 and material applicator 104 traverse a first portion and then a second portion. In one form, the second portion can be in an orientation such that gravity would have a tendency to cause more dripping than the orientation of the first portion. For example, the second portion may be closer to a vertical orientation than the first portion or gravity may act more so in the direction away from the surface of the substrate 101 (e.g., when the second portion is an underside of the substrate 101).

The control module 112 is configured to operate the heater 510 and the material applicator 104 simultaneously as they move along the path relative to the substrate 101 such that a particular portion is first preheated and then the material is applied to that preheated portion. The control module 112 is configured to operate the heater 510 to heat the substrate 101 to a temperature that is above ambient but below a boiling point of the material M. The temperature is sufficient to evaporate one or more solvents of the solvent component to increase the viscosity of the material M.

In one form, the temperature may be below the curing point of the coating component and below the boiling point of the solvent component. In one form, the temperature may be above or equal to 45° C. and, in some forms, may be above or equal to 60° C. In one form, the temperature may be equal to or below 105° C. In one form, the temperature may be sufficient to evaporate one or more solvents of the first solvent component to increase a viscosity of the first material to be equal to or above a predetermined viscosity within a predetermined timeframe of contacting the substrate 101. In one form, this predetermined viscosity may be reached within 60 seconds of the first material contacting the substrate 101. In one form, this predetermined viscosity may be reached within 30 seconds of the first material contacting the substrate 101. In another form, this predetermined viscosity may be reached within 20 seconds of the first material contacting the substrate 101. In one form, this predetermined viscosity may be 100 centipoise (0.1 newton-second per square meter). In one form, the temperature is sufficient to evaporate one or more solvents of the solvent component to increase a viscosity of the material M by a predetermined percentage within a predetermined timeframe of contacting the substrate 101. In one form, this predetermined timeframe can be 60 seconds. In another form, this predetermined timeframe can be 30 seconds. In another form, this predetermined timeframe can be 20 seconds. In one form, this predetermined percentage can be within the range of 120% to 200%, inclusive.

The control module 112 can be configured to adjust operation of the heater 510 to adjust the temperature to which it heats the portions of the substrate 101 based on the orientation of the portions of the substrate 101 relative to gravity. In the example provided above, the control module 112 can be configured operate the heater 510 to preheat the first portion to a first temperature and to preheat the second portion to a second temperature that is greater than the first temperature. The first and second temperatures are each greater than ambient temperature and less than the boiling point of the coating component. This can cause more of the solvent component to evaporate more quickly along the second portion than along the first portion to reduce running or dripping along the second portion.

Alternatively or additionally, the control module 112 can be configured to adjust operation of the heater 510 to adjust the temperature to which it heats the portions of the substrate 101 based on a characteristic of the material M being ejected as a whole or based on a characteristic of the coating component or based on a characteristic of the solvent component. For example, the control module 112 can be configured to eject a first material along one portion of the substrate 101 and a different, second material along a different portion of the substrate 101. The second material can have a different solvent component and/or a different absorptivity, and/or a different heat absorption coefficient, and/or a different heat transfer coefficient. For example, the control module 112 can be configured to adjust operation of the heater 510 such that, for a material that has a tendency to evaporate quicker, the temperature of the portions of the substrate 101 to which it will be applied will be heated less than portions of the substrate 101 to which a material that has a tendency to evaporate slower.

Referring to FIG. 7, in another form, the heater 510 can be positioned to direct heat toward an opposite side of the substrate 101 than the material applicator 104. In this form, the heater 510 may be coupled to the same robotic tool (e.g., robotic arm 102) or a separate robotic tool controlled by the control module 112 or may be stationary if a robotic tool is configured to move the substrate 101 relative to the ground.

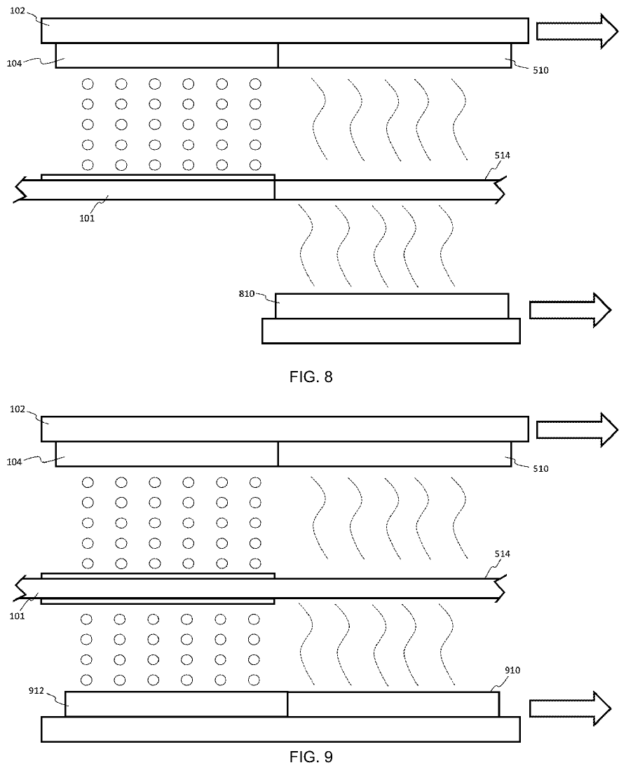

Referring to FIG. 8, in another form, a second heater 810 can be positioned to direct heat toward an opposite side of the substrate 101 than the material applicator 104 and the heater 510. In this form, the heater 810 may be coupled to the same robotic tool (e.g., robotic arm 102) or a separate robotic tool controlled by the control module 112 or may be stationary if a robotic tool is configured to move the substrate 101 relative to the ground.

Referring to FIG. 9, in another form, a second heater 910 and a second material applicator 912 can be positioned to heat and direct a material toward an opposite side of the substrate 101 than the material applicator 104 and heater 510. The material ejected by the second material applicator 912 can be the same as or different than the material ejected from the material applicator 104. The second heater 910 and second material applicator 912 can be similar to the heater 510 and material applicator 104. The second heater 910 and second material applicator 912 can be directly opposite the heater 510 and material applicator 104 and follow a similar but mirrored path on the opposite side of the substrate 101 or can follow a different path. In this form, the heater 910 and second material applicator 912 may be coupled to the same robotic tool (e.g., robotic arm 102) or a separate robotic tool controlled by the control module 112 or may be stationary if a robotic tool is configured to move the substrate 101 relative to the ground.

While not specifically shown, in any of the configurations shown and described herein, an additional heater can be mounted adjacent to the material applicator 104 and/or second material applicator 912 to follow the material applicator 104 and/or second material applicator 912 to further dry or cure the coating layer C after it is applied.

In any of the configurations shown and described herein, one or more sensors (not specifically shown) can be in communication with the control module 112 and configured to detect a temperature of the portions of the substrate 101. The sensor(s) may optionally be non-contact sensors such that they do not contact the substrate 101.

As such the present disclosure also includes a method for coating a substrate using a spray system 100 as discussed above. In the method, the control module 112 is configured to control operation of the heater(s), robotic tool(s), and material applicator(s) to perform the steps of the method.

In one form, the method includes preheating a first portion of the substrate 101 to a first temperature and ejecting a first material from the material applicator 104 so that the first material is applied to the preheated first portion of the substrate 101. The first material includes a first solvent component and a first coating component. The first temperature is greater than an ambient temperature and less than a boiling point of the first coating component.

In one form, the preheating can be performed by a heater located on a robotic tool (e.g., robotic arm 102) and the material applicator 104 can be located on the robotic tool.

In one form, the preheating can be performed by an infrared heater (e.g., heater 510).

In one form, the preheating of the first portion of the substrate 101 can be performed by a heater 510 that directs heat in a targeted manner to the first portion of the substrate 101, the first portion being less than an entirety of the substrate 101.

In one form, the preheating of the first portion of the substrate 101 can be performed by a heater (not specifically shown) that directs heat to an entirety of the substrate.

In one form, the method can include preheating a second portion of the substrate to a second temperature, the second temperature being greater than the first temperature and less than the boiling point of the first coating component. The second portion of the substrate 101 is closer to a vertical orientation than the first portion of the substrate 101. The method can further include ejecting the first material from the material applicator 104 so that the first material is applied to the preheated second portion of the substrate 101.

In one form, the method can further include adjusting the first temperature based on an orientation, with respect to gravity, of the first portion of the substrate 101.

In one form, the method can further include preheating a second portion of the substrate 101 to a second temperature, the second temperature being different than the first temperature and ejecting a second material from the material applicator 104 so that the second material is applied to the preheated second portion of the substrate 101. The second material can include a second solvent component and a second coating component that is different than the first coating component. The second temperature is greater than the ambient temperature and less than a boiling point of the second coating component.

In one form, the method can include adjusting the first temperature based on a characteristic of the first coating component, wherein the characteristic includes at least one of an absorptivity, a heat absorption coefficient, and a heat transfer coefficient.

In one form, the preheating of the first portion of the substrate can be performed by a heater (e.g., heater 510), wherein the heater is operated at the same time as the material applicator 104 ejects the first material and the method further includes moving the heater and the material applicator 104, relative to the substrate 101, along a path such that the first portion is heated by the heater before the ejected first material is applied to the first portion.

In one form, the preheating of the first portion of the substrate 101 is performed by a heater (e.g., heater 510), wherein the heater is operated at the same time as the material applicator 104 ejects the first material and the method further includes moving the substrate 101, relative to the material applicator 104 and the heater, along a path such that the first portion is heated by the heater before the ejected first material is applied to the first portion.

In one form, the first temperature is within the range of 45° C. to 105° C., inclusive.

In another form, the first temperature is within the range of 60° C. to 105° C., inclusive.

In one form, the first temperature is sufficient to evaporate one or more solvents of the first solvent component to increase a viscosity of the first material to above 0.1 newton-second per square meter within 60 seconds of the first material contacting the substrate.

In one form, the temperature may be below the curing point of the coating component and below the boiling point of the solvent component.

In one form, the temperature may be above or equal to 45° C.

In one form, the temperature may be above or equal to 60° C.

In one form, the temperature may be below 105° C.

In one form, the temperature may be sufficient to evaporate one or more solvents of the first solvent component to increase a viscosity of the first material to be equal to or above a predetermined viscosity within a predetermined timeframe of contacting the substrate 101. In one form, this predetermined viscosity may be reached within 60 seconds of the first material contacting the substrate 101. In one form, this predetermined viscosity may be reached within 30 seconds of the first material contacting the substrate 101. In another form, this predetermined viscosity may be reached within 20 seconds of the first material contacting the substrate 101. In one form, this predetermined viscosity may be 100 centipoise (0.1 newton-second per square meter).

In one form, the temperature is sufficient to evaporate one or more solvents of the solvent component to increase a viscosity of the material M by a predetermined percentage within a predetermined timeframe of contacting the substrate 101. In one form, this predetermined timeframe can be 60 seconds. In another form, this predetermined timeframe can be 30 seconds. In another form, this predetermined timeframe can be 20 seconds. In one form, this predetermined percentage can be within the range of 120% to 200%, inclusive.

In another form, the present disclosure provides for a method of coating a substrate 101 including preheating a first portion of the substrate 101 to a first temperature. The method includes ejecting a first material from a material applicator 104 so that the first material is applied to the preheated first portion of the substrate 101, the first material including a first solvent component and a first coating component. The first temperature is greater than an ambient temperature and less than a boiling point of the first coating component. The method includes preheating a second portion of the substrate 101 to a second temperature, the second temperature being greater than the first temperature and less than the boiling point of the first coating component. The second portion of the substrate 101 is closer to a vertical orientation than the first portion of the substrate. The method includes ejecting the first material from the material applicator 104 so that the first material is applied to the preheated second portion of the substrate 101.

In one form, the preheating of the first portion of the substrate 101 and the preheating of the second portion of the substrate 101 are performed by a heater (e.g., heater 510) that directs heat in a targeted manner to the first portion of the substrate 101 and in a targeted manner to the second portion of the substrate 101, the first portion being less than an entirety of the substrate 101 and the second portion of the substrate being less than the entirety of the substrate 101.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of coating a substrate comprising:
preheating a first portion of the substrate to a first temperature; and
ejecting a first material from a material applicator so that the first material is applied to the preheated first portion of the substrate, the first material including a first solvent component and a first coating component, wherein the first temperature is greater than an ambient temperature and less than a boiling point of the first coating component.

2. The method according to claim 1, wherein the preheating is performed by a heater located on a robotic tool, wherein the material applicator is located on the robotic tool.

3. The method according to claim 1, wherein the preheating is performed by an infrared heater.

4. The method according to claim 1, wherein the preheating of the first portion of the substrate is performed by a heater that directs heat in a targeted manner to the first portion of the substrate, the first portion being less than an entirety of the substrate.

5. The method according to claim 1, wherein the preheating of the first portion of the substrate is performed by a heater that directs heat to an entirety of the substrate.

6. The method according to claim 1, further comprising:
preheating a second portion of the substrate to a second temperature, the second temperature being greater than the first temperature and less than the boiling point of the first coating component, the second portion of the substrate being closer to a vertical orientation than the first portion of the substrate; and
ejecting the first material from the material applicator so that the first material is applied to the preheated second portion of the substrate.

7. The method according to claim 1, further comprising:
adjusting the first temperature based on an orientation, with respect to gravity, of the first portion of the substrate.

8. The method according to claim 1, further comprising preheating a second portion of the substrate to a second temperature, the second temperature being different than the first temperature; and
ejecting a second material from the material applicator so that the second material is applied to the preheated second portion of the substrate, the second material including a second solvent component and a second coating component that is different than the first coating component, wherein the second temperature is greater than the ambient temperature and less than a boiling point of the second coating component.

9. The method according to claim 1, further comprising adjusting the first temperature based on a characteristic of the first coating component, wherein the characteristic includes at least one of an absorptivity, a heat absorption coefficient, and a heat transfer coefficient.

10. The method according to claim 1, wherein the preheating of the first portion of the substrate is performed by a heater, wherein the heater is operated at the same time as the material applicator ejects the first material and the method further comprises:
moving the heater and the material applicator, relative to the substrate, along a path such that the first portion is heated by the heater before the ejected first material is applied to the first portion.

11. The method according to claim 1, wherein the preheating of the first portion of the substrate is performed by a heater, wherein the heater is operated at the same time as the material applicator ejects the first material and the method further comprises:
moving the substrate, relative to the material applicator and the heater, along a path such that the first portion is heated by the heater before the ejected first material is applied to the first portion.

12. The method according to claim 1, wherein the first temperature is within the range of 45° C. to 105° C., inclusive.

13. The method according to claim 1, wherein the first temperature is sufficient to evaporate one or more solvents of the first solvent component to increase a viscosity of the first material to above 0.1 newton-second per square meter within 60 seconds of the first material contacting the substrate.

14. The method according to claim 1, wherein the first temperature is sufficient to evaporate one or more solvents of the first solvent component to increase a viscosity of the first material by predetermined percentage 60 seconds of the first material contacting the substrate.

15. A method of coating a substrate comprising:
preheating a first portion of the substrate to a first temperature;
ejecting a first material from a material applicator so that the first material is applied to the preheated first portion of the substrate, the first material including a first solvent component and a first coating component, wherein the first temperature is greater than an ambient temperature and less than a boiling point of the first coating component;
preheating a second portion of the substrate to a second temperature, the second temperature being greater than the first temperature and less than the boiling point of the first coating component, the second portion of the substrate being closer to a vertical orientation than the first portion of the substrate; and
ejecting the first material from the material applicator so that the first material is applied to the preheated second portion of the substrate.

16. The method according to claim 15, wherein the preheating of the first portion of the substrate and the preheating of the second portion of the substrate are performed by a heater that directs heat in a targeted manner to the first portion of the substrate and in a targeted manner to the second portion of the substrate, the first portion being less than an entirety of the substrate and the second portion of the substrate being less than the entirety of the substrate.

17. An apparatus for coating a substrate with at least one material, the apparatus comprising:
a material applicator configured to eject the at least one material;
a heater;
at least one device configured to provide relative movement between the substrate and the material applicator and between the substrate and the heater; and
a controller in communication with the at least one device, the material applicator, and the heater, wherein the controller is configured to control operation of the at least one device, the material applicator, and the heater such that the heater directs heat toward a first portion of the substrate and the material applicator subsequently applies the at least one material to the heated first portion.

18. The apparatus according to claim 17, wherein the at least one material includes a solvent component and a coating component, wherein the controller is configured to operate the heater to heat the first portion to a first temperature that is greater than an ambient temperature and less than a boiling point of the coating component.

19. The apparatus according to claim 17, wherein the controller is configured to adjust operation of the heater to heat the first portion to a temperature that is based on an orientation of the first portion of the substrate relative to gravity.

20. The apparatus according to claim 17, wherein the controller is configured to adjust operation of the heater to heat the first portion to a temperature based on a characteristic of the at least one material, wherein the characteristic includes at least one of an absorptivity, a heat absorption coefficient, and a heat transfer coefficient.
